(19) United States
(12) Patent Application Publication
(10) Pub. No.: US 2003/0098378 A1
(43) Pub. Date: May 29, 2003

(54) Structure of a water-hose retracting device

(76) Inventor: Chih Jen Chen, Taipei City (TW)

Correspondence Address: CHEN Chih Jen, PO Box 82-144, Taipei, TW

(21) Appl. No.: 09/994,738

(22) Filed: Nov. 28, 2001

(51) Int. Cl. B65H 75/48; A62C 35/00

(52) U.S. Cl. 242/385.1; 137/355.23

(57) ABSTRACT

A structure of a water-hose retracting device is disclosed. The structure a hose retracting frame, a covering plate, an axial tube module, a hose accessing frame and a rotating reel, and in combination with a ratchet wheel and an urging block, characterized in that the axial tube module is positioned at the hose retracting frame, and the interior of the hose body is engaged with the rotating reel which can be tightened by rotating, thereby by means of the urging block with the ratchet wheel, an appropriate length of the hose can be accessed.

### BACKGROUND OF THE INVENTION

(a) Technical Field of the Invention

The present invention relates to a retracting device for water hose, and in particular, a water hose that can be retracted without extra labor force.

(b) Description of the Prior Art

Conventional water-hose retracting devices available in the market are of two types, i.e., manually operation and electrically operated, wherein the manually operated water-hose retracting device makes use of a hard shaft to drive the water hose. The structure of the retracting device is simple to operate but it requires time to maintain or to properly install when it is needed. The electrically operated retracting device allows automatic retracting of the water hose, but at places where no power supply is available, the retracting device cannot be used, and in addition, current leakage may be occurred in the electrically operated retracting device as the device may have close contact with water. Accordingly, it is an object of the present invention to provide a structure of a water-hose retracting device, which mitigates the above-mentioned drawbacks.

### SUMMARY OF THE INVENTION

Accordingly, it is an object of the present invention to provide a structure of a water-hose retracting device, wherein the retracting device comprises a hose retracting frame, a covering plate, an axial tube module, a hose accessing frame and a rotating reel, and in combination with a ratchet wheel and an urging block, characterized in that the axial tube module is positioned at the hose retracting frame, and the interior of the hose body is engaged with the rotating reel which can be tightened by rotating, thereby by means of the urging block with the ratchet wheel, an appropriate length of the hose can be accessed.

Yet another object of the present invention is to provide a structure of a water-hose retracting device, wherein the retracting frame is mounted onto a securing seat on the wall surface by suspension.

A further object of the present invention is to provide a structure of a water-hose retracting device, wherein an appropriate length of a water hose can be accessed for cleaning application or irrigation purpose by pulling one end of the hose to trigger the urging block.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of the present invention.

FIG. 2 illustrates the connection between the axial tube and the water outlet tube in accordance with the present invention.

FIG. 3A is a sectional view of the axial tube module in accordance with the present invention.

FIG. 3B is an enlarged view of a portion of FIG. 3A;

FIG. 4A shows the operation of the retracting frame in accordance with the present invention.

FIG. 4B is a sectional view of FIG. 4A.

FIG. 5A is a sectional view of the covering plate of the present invention.

FIG. 5B is a sectional view of FIG. 5A.

FIG. 6 is a schematic view of the water-hose retracting device of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

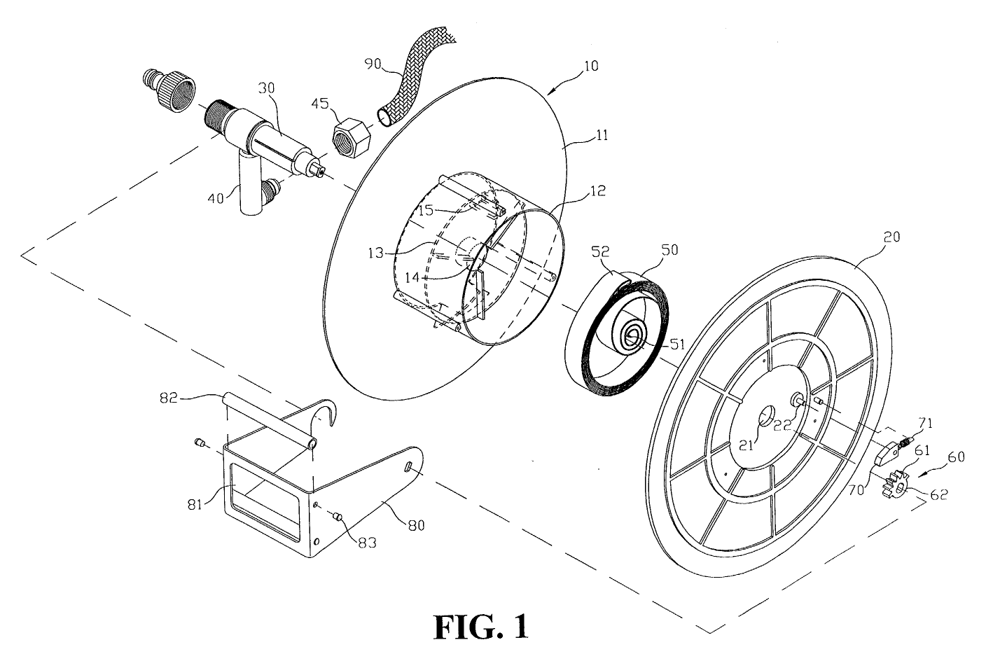

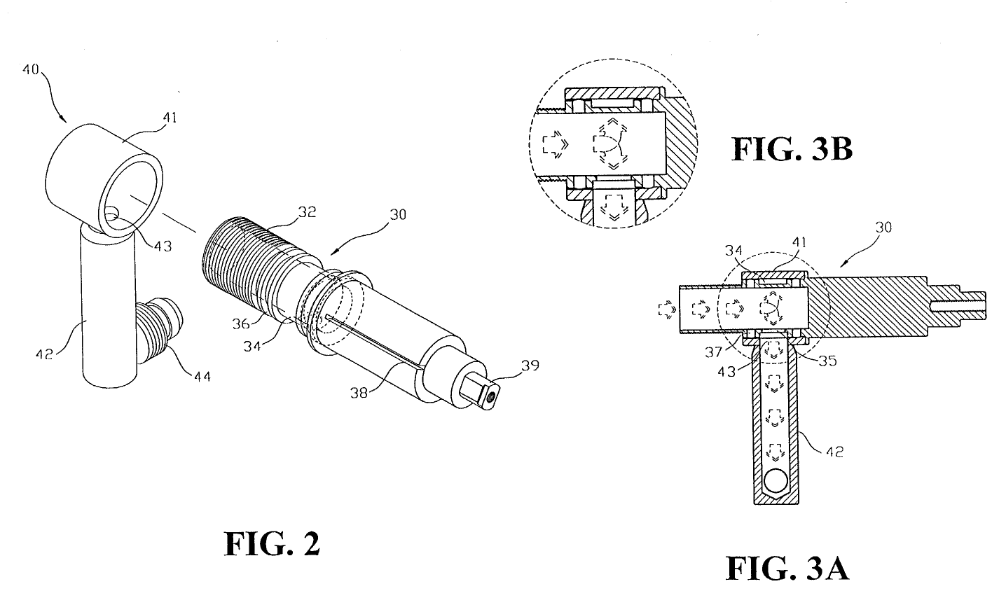

Referring to FIGS. 1, 2, 3A and 3B, an automatic water-hose retracting device according to the present invention comprises a hose retracting frame 10 for winding of the water-hose on to a reeling disc 11 thereof. A cylindrical body 12 is located at one lateral side of the reeling disc 11, and an isolation plate 13 divides the cylindrical body 12 into equal space. A circular hole 14 is provided to the reeling disc 11 at the center thereof and is used for the mounting of an axial tube module 30 for the mounting of a hose. The isolation plate 13 forms a cavity slot, and at the upper edge of the cavity slot a fastening plate 15 is provided for the mounting of a rotational triggering chain.

The axial tube module 30 has an axial tube 31 and the rear end of the tube 31 is provided with a plurality of teeth 32 having teeth slots 33. The rear end of the axial tube 31 is used for the mounting of the waterhose. The front section of the teeth 32 is provided with a notch section 34, and the bottom of the notch section 34 has a throughhole 35. The sides of the throughhole 35 are provided with a circular slot 36 which is higher than the notch section for mounting with a sealing rubber rim 37 so that the circular section 41 and the axial tube 31 are sealed together. The bottom section of the mounting rim 37 is provided with a shaft rod 42 having a through hole 43; thereby a flowing path is obtained. The shaft rod 42 has a threaded mounting tube 44 allowing water hose disk to surround onto the circular tube body 12. The front end of the shaft rod section is a slot 38 for fastening with a triggering chain 50, and a ratchet wheel 60 at the front end thereof is made into a parallel fastening shaft rod section 39.

The triggering chain 50 is strap-like elastic plate, and a hook section 51 is provided to the innermost ring of the plate for mounting with the slot 38. The end of the elastic plate has a clipping section 52 so that it can be mounted with the fastening plate 15 so that the triggering chain 50 can be mounted to the circular tube body 12.

A covering plate 20 is used to lock the circular tube body 12 to form a unit, and the center of the plate 20 is a circular hole 21 for the mounting of a shaft tube 31. Two rods are provided at equal distance along the circumferential edge of the covering plate 20. One of the rods is for fastening of the urging block 70 and the other rod is for the fastening of the rod to the spring 71.

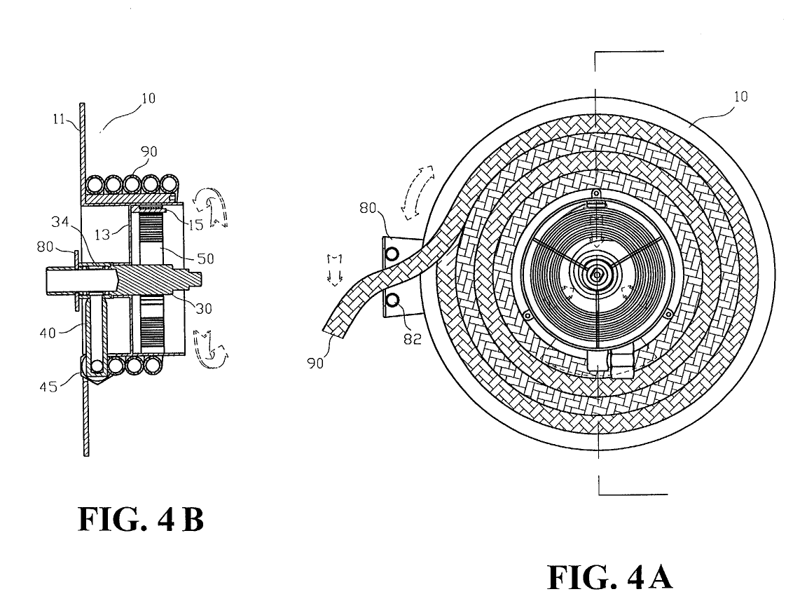

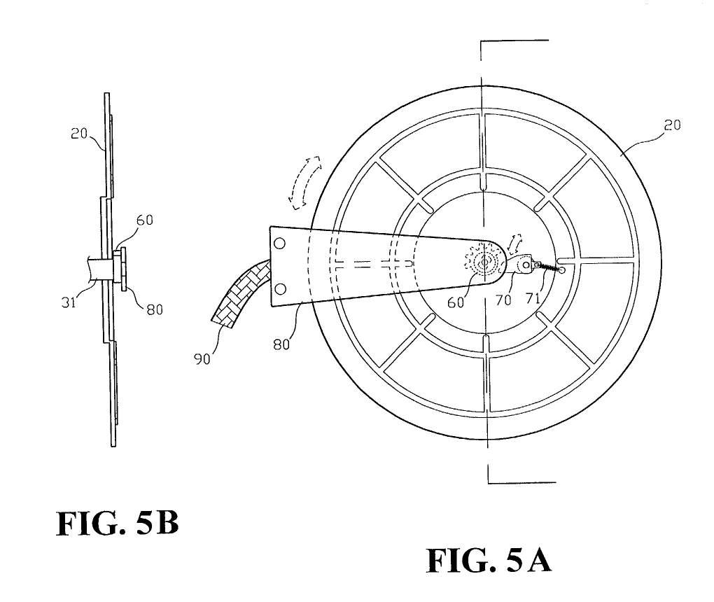

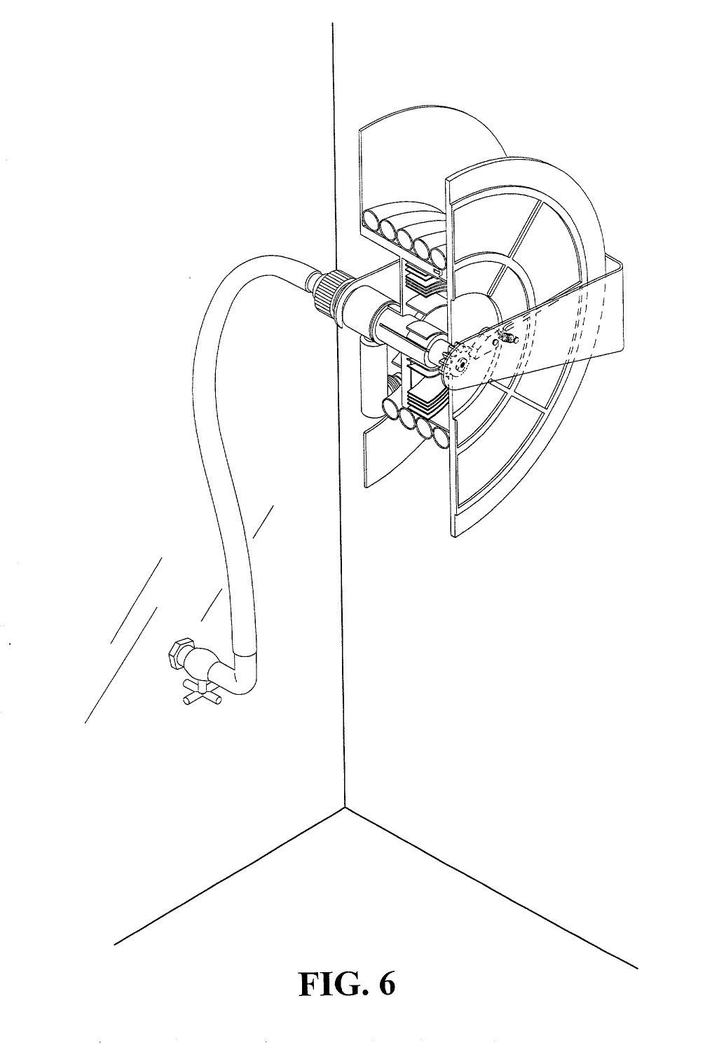

FIGS. 4A, 4B, 5A and 5B show the operation of the automatic retracing water-hose and FIG. 6 shows the preferred embodiment in accordance with the present invention. The mounting ring 41 of the water outlet tube 40 is mounted onto the shaft tube 31 and passes through the circular hole 14, and the hook 51 is fastened to the slot 38, and the clipping section 52 is mounted onto a fastening plate 15. The triggering chain 50 is mounted to the circular tube body 12 and one end of the water hose 90 is mounted onto the mounting tube 44 and a nut 45 is used for mounting to the mounting tube 44 as a unit. The ratchet wheel 60 is fastened to the shaft section of the external end of the shaft rod, and the urging block 70 and the spring 21 are engaged with the rod 22 at the top cover. The water-hose accessing frame 80 is mounted to the axial tube module 30 and the water hose is pulled out of the through hole 35. The top and bottom water hose accessing frame 80 are provided with circular tube 82, and rivet 83 is used for positioning.

When the water hose 90 is pulled out, the water hose retracting frame rotates and the water hose 40 will rotate about the axial tube. When the water hose is pulled, the trigger chain 50 is tightened and the urging block 70 urges the teeth 61 of the ratchet wheel 60 and the length of the water hose is fixed. If a further length of the water hose is needed, the water hose is pulled and the urging block 70 will dislocate from the teeth to slide to a smooth section 62 on the ratchet wheel 60. When the water hose is pulled, the triggering chain 50 is tightly rotated and when the urging block 70 is disengaged with the teeth, the triggering chain 50 is instantaneously extended outside and rapidly rolls the water hose. The fastening block at the end of the water hose prevents the entire water hose from retracting into the circular tube body. Therefore, the present structure provides a rapid retrieving and retracting of water hose so that the water hose will not become a cluster.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spit of the present invention.

I claim:

1. A structure of a water-hose retracting device comprising a hose retracting frame, a covering plate, an axial tube module, a hose accessing frame and a rotating reel, and in combination with a ratchet wheel and an urging block, characterized in that the axial tube module is positioned at the hose retracting frame, and the interior of the hose body is engaged with the rotating reel which can be tightened by rotating, thereby by means of the urging block with the ratchet wheel, an appropriate length of the hose can be accessed.

2. The structure of a water-hose retracting device of claim 1, wherein the retracting frame is mounted onto a securing seat on the wall surface by suspension.
